(19) United States
(12) Patent Application Publication
(10) Pub. No.: US 2021/0255465 A1
(43) Pub. Date: Aug. 19, 2021

(54) SMART GLASS DISPLAY DEVICE FOR BOTH AUGMENTED REALITY AND VIRTUAL REALITY COMPRISING PLASTIC LCD SHADE

(71) Applicant: VISIONAID INC., Pocheon-si, Gyeonggi-do (KR)

(72) Inventors: Kyo Wung LEE, Suwon-si (KR); Sung Il KIM, Pyeongtaek-si (KR); Man Bok PARK, Seongnam-si (KR)

(73) Assignee: VISIONAID INC., Pocheon-si, Gyeonggi-do (KR)

(21) Appl. No.: 17/252,673

(22) PCT Filed: Jun. 27, 2019
(86) PCT No.: PCT/KR2019/007796

§ 371 Date: Dec. 15, 2020

(30) Foreign Application Priority Data
Jun. 27, 2018 (KR) 10-2018-0073944

(51) Int. Cl. G02B 27/01; G02F 1/1343

(52) U.S. Cl. CPC G02B 27/0172; G02F 1/13439; G02B 2027/0174; G02B 2027/0118; G02B 2027/0138

(57) ABSTRACT

The present invention relates to a smart glass display device capable of implementing virtual reality and augmented reality by controlling the transmittance of external light from a shade which acts as a smart glass display shutter according to user selection and is made of a plastic LCD panel. The smart glass display device comprises: a glasses-type frame; first and second micro-display units which are arranged in the frame and generate virtual reality and augmented reality; first and second optical engine units on which images generated from the first and second micro-display units are displayed; first and second shades which are installed at the front surfaces of the first and second optical engine units and are made of plastic LCD panels capable of shielding or transmitting external light; an illumination sensor installed in the frame; and a camera for outdoor photography. The first and second shades are configured to dim binocularly or monocularly to the extent desired by a user, on the basis of information from the illumination sensor and the camera, and thus a wider range of content can be experienced by selecting virtual reality or augmented reality or by using both simultaneously.

### TECHNICAL FIELD

The present invention relates to a smart glass display device manufactured to be capable of simultaneously or selectively implementing augmented reality and virtual reality, and more particularly, to a smart glass display device capable of implementing virtual reality and augmented reality by controlling the transmittance of external light from a shade which acts as a smart glass display shutter according to user selection and is formed of a plastic LCD panel.

### BACKGROUND ART

Virtual reality (VR) is a technology that creates a virtual environment to make a user feel like a real thing. Augmented reality (AR) is a technology that projects and expresses virtual information in an actual surrounding environment. In recent years, augmented reality (AR) and virtual reality (VR) have been developed in the form of mixed reality (MR) and augmented virtual (AV) in which reality and virtual information are simultaneously fused to build an environment, based on the concept of reality-virtuality continuum.

In addition, a head mounted display (HMD) refers to a display device that is worn on the user's head. The head-mounted display is used as a display device for implementing the above-described virtual reality or augmented reality, and the utility thereof has been gradually increased in recent years.

Such a head-mounted display may be classified into a closed type or a see-through type according to the type. The closed type head mounted display covers the entire user's eyes to block external environments other than the screen, and is mainly used together with virtual reality contents. In addition, the see-through type head-mounted display, which is referred to as a glasses-type display or a smart glass, enables the user to view real objects and virtual screens at the same time, and is mainly used to implement mixed reality such as augmented reality.

Such a smart glass display device allows the user wearing the device to recognize an image by displaying the image on the screen covering both eyes of the user when displaying the image in front of the user. In this case, the screen on which an image is displayed is formed of glass or plastic. In addition, since the smart glass display device is small and lightweight, and allows images to be displayed close to both eyes of the user, the displayed image may be recognized as a large screen.

Meanwhile, in the case of smart glasses for outdoor, in order to selectively use virtual reality and augmented reality, safety-related functions that are essential for outdoor activities has to be applied. For example, in the case of a conventional product, when controlling a d drone, the controller must take off the goggles worn to recognize the surrounding situation.

Examples of such techniques are disclosed in the following documents.

For example, there has been disclosed an electronic device in Korean Unexamined Patent Publication No. 2017-0005692 (published on Jan. 16, 2017), which includes a display, a communication module, a sensor module, a processor electrically connected to the display, the communication module and the sensor module, and a memory electrically connected to the processor, where the memory stores instructions that, when executed, cause the processor to detect a content selection of a user identify a reference element corresponding to the contents, determine a display mode corresponding to the reference element, and output the contents based on the display mode. The display mode includes an augmented reality mode, a virtual reality mode and a mixed reality mode.

In addition, there has been disclosed a head mounted display device in Korean Registered Patent No. 10-1817952 (registered on Jan. 18, 2018), which includes an optical unit for displaying a virtual screen, a front lens 102 configured to be positioned on both eyes to allow the wearer see an outside, an image capturing module 104 configured to acquire an image in the same direction as the front direction of the wearer, and an image processing unit 106 that calculates the depth of the wearer's gaze point from the image acquired through the image capturing module 104 and dynamically controls the depth of the virtual screen according to the calculated depth.

Meanwhile, there has been disclosed a wearable electronic device in Korean Unexamined Patent Publication No. 2014-0130332 (published on Nov. 10, 2014), which includes a transparent or light-transmitting lens unit, a camera unit for photographing a foreground perceived by a wearer's view of the wearable electronic device, a communication unit that transmits a real image corresponding to the photographed foreground to a server for providing location information, a display unit for displaying additional information on the lens unit to provide visual additional information in addition to the foreground perceived by the wearer's view of the wearable electronic device, and when the operation mode of the wearable electronic device is a navigation mode, a control unit that receives location information calculated by the server according to the transmitted real image, generates direction information to a destination based on the received location information, and controls the display unit to display the generated direction information as the additional information.

### DISCLOSURE

### Technical Problem

In the manual type detachable shade mainly used in the technology disclosed in the patent documents as described above, it is difficult to secure user convenience and safety. That is, there are inconveniences in the manual operation of the shade of the conventional smart glass and safety problems that occur when used outdoors.

To solve the problems described above, an object of the present disclosure is to provide a smart glass display device for augmented reality and virtual reality having a shade in which a plastic LCD panel having a fast response speed (50 ms or less) is mounted as a shade of smart glass so that it is possible to secure a weight (100 g or less) sufficient to do activities such as driving of a motorcycle or a car, controlling of a drone, and the like while the smart glasses are worn, and which is not damaged even by impact such as a fall by applying a plastic material and is capable of being processed in a curved shape.

Another object of the present disclosure is to provide a smart glass display device for augmented reality and virtual reality having a shade which is formed of a plastic LCD material, is configured to wrap the liquid crystal layer with a flexible transparent film to have flexibility, reduce thickness and weight to provide excellent fit, and be mounted on a smart glass to control external light transmittance.

Still another object of the present invention is to provide a smart glass display device for augmented reality and virtual reality which provides video and audio information from an external device (a computer, a camera, etc.) wired or wirelessly for experiences such as augmented reality (AR) experience and virtual reality (VR) experience, and includes an optical see-through lens that allows information (video and audio) to be superimposed on a user's real world view.

Still another object of the present disclosure is to provide a smart glass display device for augmented reality and virtual reality that can be used at least in the defense industry, aeronautics, engineering, science, medicine, computer games, video, sports, training, simulation, and other applications, as a head-mounted display (HMD) in the form of a helmet, visor, glasses, or goggles.

### Technical Solution

According to one aspect of the present disclosure, there is provided a smart glass display device for augmented reality and virtual reality having a plastic LCD shade, which includes a glasses-type frame; first and second micro-display units which are arranged in the frame and generate virtual reality and augmented reality; first and second optical engine units on which images generated from the first and second micro-display units are displayed; first and second shades which are installed on front surfaces of the first and second optical engine units and are formed of plastic LCD panels having a function of shielding or transmitting external light; and an illumination sensor installed in the frame; and a camera for photographing an outside, wherein the first and second shades are configured to dim binoculars or a monocular at a degree desired by a user, based on information from the illumination sensor and the camera.

Each of the first and second shades may include an upper flexible transparent film formed with an upper transparent electrode; a lower flexible transparent film formed with a lower transparent electrode; a liquid crystal layer formed between the upper transparent electrode and the lower transparent electrode; a spacer for maintaining a gap of the liquid crystal layer in the liquid crystal layer; and a connector for applying an electrical signal to the upper transparent electrode or the lower transparent electrode.

The flexible transparent film may include one of polycarbonate (PC), polyimide (PI), and cyclo-olefin polymer (COP), and equipped with a moisture permeable defense function of 10⁻³ g/day˜10⁻⁶ g/day, and a substrate may be formed by forming a transparent electrode on the flexible transparent film serving as a base layer, and the substrate has a thickness of 30 to 300 μm.

The transparent electrode may be mainly formed of a metal oxide including one of ITO, IZO, and AZO, and have a transmittance in a range of 80 to 120% compared to a 550 nm substrate, and a thickness in a range of 5 to 500 nm.

The transparent substrate may be provided with a moisture prevention barrier, the moisture prevention barrier may be formed by laminating a single layer or a mixed layer of an organic thin film and an inorganic thin film, the inorganic thin film may be formed through sputtering, PECVD or PEALD, the organic thin film may be formed through doctor blade, spin coating, gravure coating or printing, a material of the inorganic thin film may include one of SiO₂, Al₂O₃, SiN_{X}, SiC, SiOC and SiON, the single layer formed of the inorganic thin film may have a thickness of 5 to 1,000 nm, the organic thin film may mainly include a Si-based compound, an acrylic-based compound or an urethane-based compound, and the single layer formed of the organic thin film may have a thickness of 5 to 5,000 nm.

A liquid crystal of the liquid crystal layer may be formed in a TN mode (a pre-tilt angle of 0.3 to 5 deg.) or a VA mode (85 to 90 deg.) by performing an alignment process on a transparent electrode portion of the transparent plastic substrate with an organic thin film or an inorganic thin film, and cell gaps of the first and second shades may be 5 μm or less.

The first and second shades may be configured in a form of goggles in which left and right eyes are separately manufactured and installed, or the left and right eyes are manufactured together, and a transmittance of the first and second shades may be 5% to 95% based on a transmittance of the substrate.

The smart glass display device may further include a display module that receives image and audio information in a wired-wireless manner from an external device including a computer or a camera to increase a dimmable range, wherein the first and second optical engine units are equipped with optical see-through holographic lenses that allow the image information and the audio information provided virtually in an augmented reality experience to be superimposed on a real world view of a user.

Each of the first and second shades may have a response speed of 50 ms or less, and have a weight of 100 g or less.

### Advantageous Effects

As described above, the smart glass display device for augmented reality and virtual reality according to the present invention display device can be automatically in a transmission or blocking state according to the request of the device wearer, so that it is possible to select virtual reality (VR mode/shade blocking state) and augmented reality (AR mode/transmissive state) or use both, thereby allowing the user to experience a wider range of contents and reinforcing safety functions that are indispensable outdoors.

In addition, according to the smart glass display device for augmented reality and virtual reality of the present invention, when controlling the drone, the shade of one of both eyes can be changed to a blocking type and fixed to the camera of the drone, while the other is changed to a transparent type, so that the wearer can recognize the surrounding situation.

### DESCRIPTION OF DRAWINGS

FIG. 1 is a perspective view of a head mounted display device according to the related art.

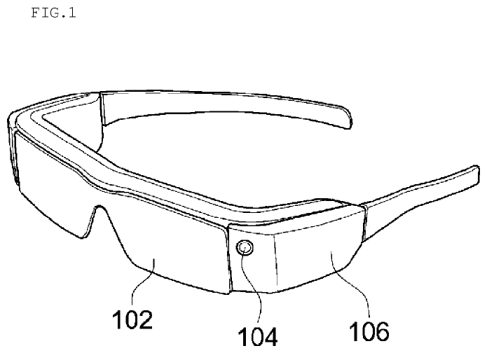

FIG. 2 is a view illustrating an overall structure of a smart glass display device for augmented reality and virtual reality having a plastic LCD shade according to the present invention.

FIG. 3 is a diagram illustrating operations of the first micro-display unit for generating an image when a virtual reality is applied and the first shade produced with made of a plastic LCD for blocking external light in the smart glass display device according to the present invention.

FIG. 4 is a diagram illustrating operations of the second micro-display unit for generating an image when augmented reality is applied and the second shade formed of a plastic LCD that transmits external light in the smart glass display device according to the present invention.

FIG. 5 is a structural diagram of the first and second shades and formed of plastic LCDs applied to a smart glass display device 1 for augmented reality and virtual reality according to the present invention.

### BEST MODE

### Mode for Invention

The above and other objects and new features of the present invention will become more apparent from the description of the present specification and the accompanying drawings.

As used herein, the term “shade” refers to a shield formed of a semi-transparent or light-diffusing material designed such that a light source is not directly visible from a normal perspective.

In a smart glass display device for both augmented reality and virtual reality having a plastic LCD shade according to the present invention, when a plastic LCD shutter is applied as a shade of a smart glass, the smart glass display device may be in a transparent or blocked state according to a request of the device wearer, so that virtual reality (VR Mode/shade blocking state) and augmented reality (AR Mode/transmissive state) may be selected or used simultaneously to experience a wider range of contents. In addition, safety functions that are indispensable in the outdoors may be reinforced. For example, in the case of drone control, one of the shades of binoculars may be changed into a blocking state and fixed to the drone's camera, while the other is changed into a transparent state, so that the smart glass display device may be adjusted to allow the wearer to recognize the surrounding situation.

To this end, the present invention provides various embodiments for a shade equipped with a dimming module shutter function capable of adjusting the amount of external light transmitted to a user through a see-through type smart glass device. The dimming module includes at least one plastic LCD cell capable of variable concentration dimming (or selectable dimming level/ambient light transmittance) so that the smart glass device can be used in augmented reality (AR) and/or virtual reality (VR) applications. Include. AR applications may prefer partial dimming of external light, that is, a transmission (shade transparent) state, and VR applications may prefer an opaque (shade external light blocking) state. A device with a dimming module may be included in a visor or other types of head mount displays. The device may be placed by a supporting structure of HMD, such as a visor or a frame of glasses.

In addition, in the present invention, the dimming degrees of glasses of the shade may be selected differently or equally such that the user of the smart glass maybe selectively used for virtual reality and augmented reality or all.

Hereinafter, an embodiment of the present invention will be described with reference to the drawings.

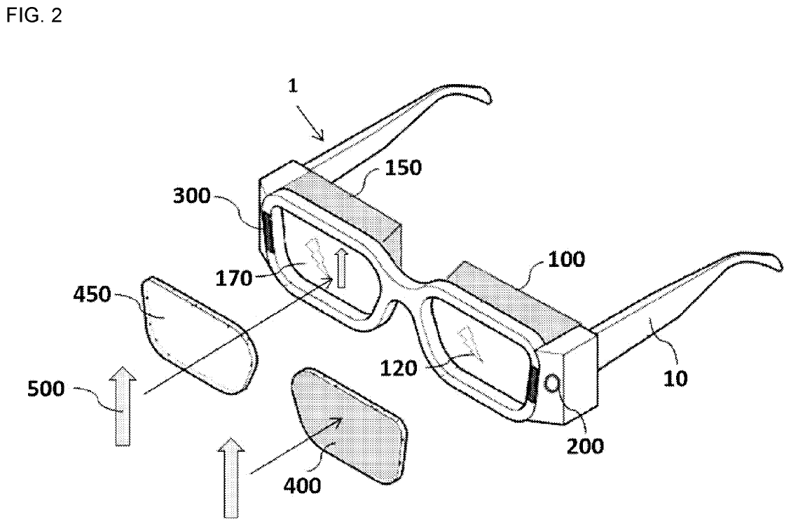

FIG. 2 is a view illustrating an overall structure of a smart glass display device for augmented reality and virtual reality having a plastic LCD shade according to the present invention.

As shown in FIG. 2, a smart glass display device for augmented reality and virtual reality having a plastic LCD shade according to the present invention includes a glasses-type frame 10, first and second micro-display units 100 and 150 provided on the frame 10 to generate virtual reality and augmented reality, first and second optical engine units 120 and 170 for displaying a generated image, first and second shades 400 and 450 formed of plastic LCD panels and mounted on the front surfaces of the first and second optical engine units 120 and 170 to block or transmit external light, and an illuminance sensor 200 and an external camera 300 mounted on the frame 10, where the first and second shades 400 and 450 dim binoculars or a monocular at a degree desired by a user, based on information from the illumination sensor 200 and the camera 300. In addition, in FIG. 2, reference numeral 500 denotes an external light generation source.

In addition, the smart glass display device for augmented reality and virtual reality having a plastic LCD shade according to the present invention may include a display module that wiredly and wirelessly provides video and audio information from an external device (e.g., a computer, a camera, etc.).

The first and second optical engine units 120 and 170 include optical see-through holographic lenses that allow virtually provided information (video and audio) to be superimposed on a user's real world view.

When the smart glass display device 1 according to the present invention is used, the first and second shades 400 and 450 may be automatically in a transmissive state or a blocked state according to the request of the wearer to select virtual reality (VR mode/shade blocking state) or augmented reality (AR mode/transmissive state), or may be used together to allow the wear to experience a wider range of contents. In addition, additional safety functions, which are indispensable in outdoors, may be reinforced.

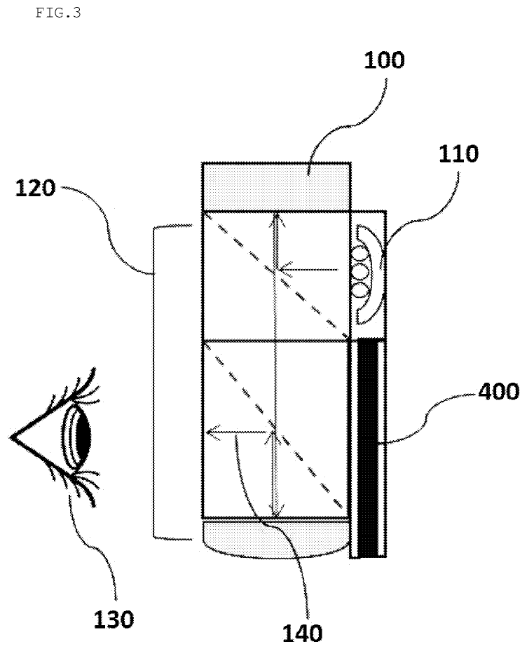

FIG. 3 is a diagram illustrating operations of the first micro-display unit 100 for generating an image when a virtual reality is applied and the first shade 400 formed of a plastic LCD for blocking external light in the smart glass display device 1 according to the present invention.

The first micro-display unit 100 includes an LED backlight 110 capable of sequentially emitting RGB light.

First, the operation of the first shade 400 will be described. The light generated from the LED backlight 110 passes through a prism lens and a poly(butylene succinate) (PBS) film in the first optical engine unit 120 and enters a reflective micro-display (LCOS, DLP, reflective LCD device) to reflect image information. The reflected image information reaches the user's eyes 130 along a schematic optical path 140. In this case, as shown in FIG. 3, the first shade 400 formed of the plastic LCD described above may block external light to allow the user's eyes 130 to focus only on the image transmitted along the optical path 140 from the micro-display.

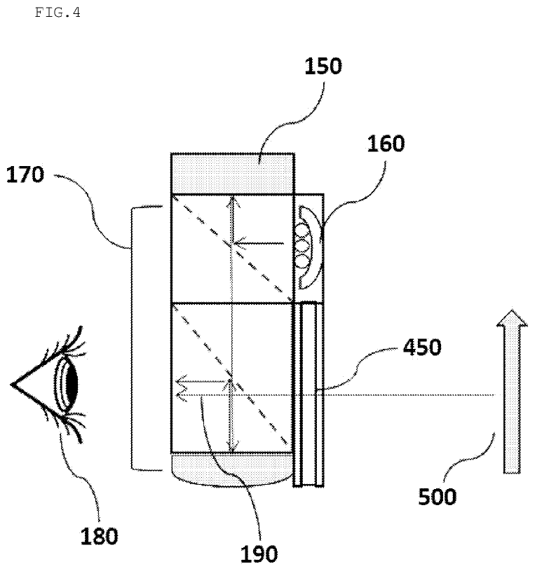

FIG. 4 is a diagram illustrating operations of the second micro-display unit 150 for generating an image when augmented reality is applied and the second shade 450 formed of a plastic LCD that transmits external light in the smart glass display device 1 according to the present invention.

The second micro-display unit 150 includes an LED backlight 160 capable of sequentially emitting RGB light.

The light generated from the LED backlight 160 passes through a prism lens and a PBS film in the second optical engine unit 170 and enters a reflective micro-display (LCOS, DLP, and reflective LCD device) to reflect image information. The reflected image information reaches the user's eyes 180 along a schematic optical path 190. In this case, as shown in FIG. 4, the second shade 450 formed of the above-described plastic LCD transmits external light to allow the user's eyes 180 to combine the image transmitted through the optical path 190 from the micro-display with information transmitted from the illumination sensor 200 mounted on the glasses-type frame 10 and the camera 300 for photographing an outside, thereby providing an environment in which the user may focus on augmented reality.

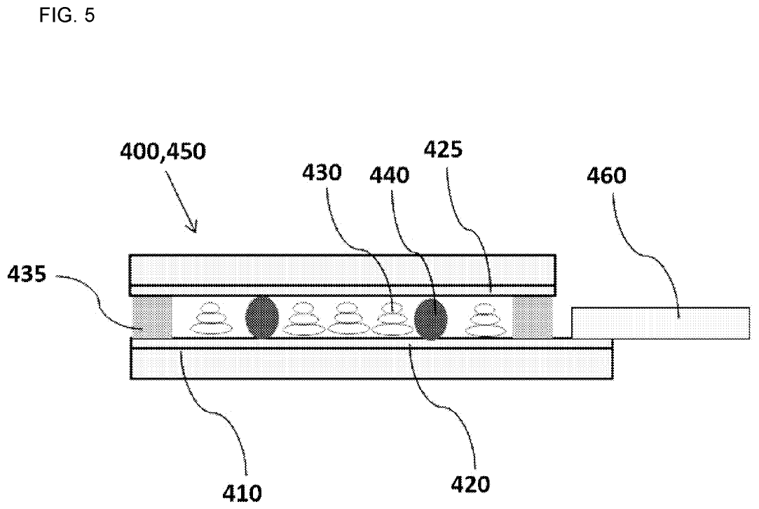

FIG. 5 is a structural diagram of the first and second shades 400 and 450 formed of plastic LCDs applied to a smart glass display device 1 for augmented reality and virtual reality according to the present invention.

As shown in FIG. 5, each of the first and second shades 400 and 450 includes an upper flexible transparent film formed with an upper transparent electrode 425, a lower flexible transparent film formed with a lower transparent electrode 420, a liquid crystal layer 430 formed between the upper transparent electrode 425 and the lower transparent electrode 420, a sealant 435 used for sealing an LCD panel, a spacer 440 for maintaining a gap of the liquid crystal layer 430 therein, and a connector 460 for applying an electrical signal to the upper transparent electrode 425 and the lower transparent electrode 420. The transparent electrode may perform a function of a screen or a lens of HMD, and the flexible transparent film 410 is used as a plastic substrate.

As described above, the flexible transparent film 410 is configured to surround the liquid crystal layer 430, and the first and second shades 400 and 450 of the smart glasses are mounted on a plastic LCD panel having a fast response speed (50 ms or less). Thus, it is possible to secure enough weight (100 g or less) to enable the user to do outdoor activities such as driving a motorcycle or a car, controlling a drone, and the like even while even while wearing the smart glasses. Since a plastic material is applied, it is not damaged even by impact such as falling, and it is possible to process a curved surface.

The flexible transparent film 410 is formed of a transparent plastic material having isotropic properties such as polycarbonate (PC), polyimide (PI), cyclo-olefin polymer (COP), and the like, and has a certain degree of moisture prevention function (10⁻⁴ g/day˜10⁻⁶ g/day). As shown in FIG. 5, each of the first and second shades 400 and 450 uses a substrate having a flexible transparent film 410 as a base and a transparent electrode formed on at least one surface of the flexible transparent film 410. Such a transparent substrate is provided to have a thickness of 30˜300 μm.

In addition, the upper transparent electrode 425 and the lower transparent electrode 420 formed on the flexible transparent film 410 includes a metal oxide such as ITO, IZO, AZO, or the like, as the main material. The transmittance should be in the range of 80 to 120% of the reference substrate of 550 nm, and the thickness of the transparent electrode is in the range of 5 nm to 500 nm.

In addition, the moisture prevention barrier used for the transparent substrate is formed by laminating a single layer or a mixed layer of an organic thin film and an inorganic thin film, where the inorganic thin film is formed through sputtering, PECVD or PEALD, and the organic thin film is formed through various schemes for forming an organic thin film, such as doctor blade, spin coating, gravure coating, printing, etc.

The material of the inorganic thin film described above may include one of SiO₂, Al₂O₃, SiN_{X}, SiC, SiOC and SiON. As the formation scheme, sputtering, PECVD, PEALD, or the like may be used. The thickness for forming a single layer is preferably 5 nm to 1,000 nm.

the organic thin film includes a Si-based compound, an acrylic-based compound or an urethane-based compound, and the single layer formed of the organic thin film has a thickness of 5 to 5,000 nm.

In addition, the structure of the first and second shades 400 and 450 may be formed in a flat or curved structure to surround the user's field of view (FOV). The driving mode of the liquid crystal, which is a constituent material in the shade, may be selected at the time of initial production (TN mode or VA mode) so that the user may select and purchase it as needed. In the transparent plastic substrate, an alignment process is performed with an organic thin film or an inorganic thin film on the transparent electrode to form the liquid crystal of the liquid crystal layer 430 in the TN mode (pre-tilt angle 0.3 to 5 deg.) or VA mode (80 to 90 deg.).

Each cell gap of the first and second shades 400 and 450 formed of the above-described plastic LCD is preferably manufactured to be 5 μm or less by using the sealant 435 and the spacer 440.

The first and second shades 400 and 450 may apply a predetermined amount of electrical signals through the connector 460 from a control circuit (not shown) to the liquid crystal layer 430 in response to a dimming value to adjust the dimming amount. The dimming value adjusts and determines a response degree of the liquid crystal inside the shutter based on the ambient light intensity value from the mounted illuminance sensor 200, the user preference value, and the type of an executed application.

In addition, according to the present invention, a plurality of plastic LCD modules may be combined to increase a dimmable range.

As described above, the first and second shades 400 and 450 may be manufactured and mounted for left and right eyes, respectively, or may have a shape of goggles in which the left and right glasses manufactured together. The transmittance of the first and second shades 400 and 450 may be 5% to 95% compared to the substrate.

The transmittance of the first and second shades 400 and 450 may be controlled based on the signal transmitted through the illuminance sensor 200 mounted on one or a plural portions of the smart glass, or may be arbitrarily controlled through the voice and switch manipulation of the user.

Although the present invention made by the present inventor has been described in detail according to the above embodiments, the present invention is not limited to the above embodiments, and can be changed in various manners without departing from the scope of the present invention.

### INDUSTRIAL APPLICABILITY

By using the smart glass display device for augmented reality and virtual reality according to the present invention, virtual reality (VR mode/shade blocking state) and augmented reality (AR mode/transmission state) may be selected or simultaneously used, thereby allowing the user to experience a wider range of contents.

1. A smart glass display device for augmented reality and virtual reality having a plastic LCD shade, the smart glass display device comprising:
a glasses-type frame;
a first and a second micro-display units which are arranged in the frame and generate virtual reality and augmented reality;
a first and a second optical engine units on which images generated from the first and second micro-display units are displayed;
a first and a second shades which are installed on front surfaces of the first and second optical engine units and are formed of plastic LCD panels having a function of shielding or transmitting external light; and
an illumination sensor installed in the frame; and
a camera for photographing an outside,
wherein the first and second shades are configured to dim binoculars or a monocularat a degree desired by a user, based on information from the illumination sensor and the camera.

2. The smart glass display device of claim 1, wherein each of the first and second shades includes an upper flexible transparent film formed with an upper transparent electrode;
a lower flexible transparent film formed with a lower transparent electrode;
a liquid crystal layer formed between the upper transparent electrode and the lower transparent electrode;
a spacer for maintaining a gap of the liquid crystal layer in the liquid crystal layer; and
a connector for applying an electrical signal to the upper transparent electrode or the lower transparent electrode.

3. The smart glass display device of claim 2, wherein the flexible transparent film includes one of polycarbonate (PC), polyimide (PI), and cyclo-olefin polymer (COP), and equipped with a moisture permeable defense function of 10⁻³ g/day˜10⁻⁶ g/day, and
wherein a substrate is formed by forming a transparent electrode on the flexible transparent film serving as a base layer, and the substrate has a thickness of 30 to 300 μm.

4. The smart glass display device of claim 3, wherein the transparent electrode is mainly formed of a metal oxide including one of ITO, IZO, and AZO, and has a transmittance in a range of 80 to 120% compared to a 550 nm substrate, and a thickness in a range of 5 to 500 nm.

5. The smart glass display device of claim 4, wherein the transparent substrate is provided with a moisture prevention barrier,
the moisture prevention barrier is formed by laminating a single layer or a mixed layer of an organic thin film and an inorganic thin film,
the inorganic thin film is formed through sputtering, PECVD or PEALD,
the organic thin film is formed through doctor blade, spin coating, gravure coating or printing,
a material of the inorganic thin film includes one of SiO₂, Al₂O₃, SiNₓ, SiC, SiOC and SiON,
the single layer formed of the inorganic thin film has a thickness of 5 to 1,000 nm,
the organic thin film mainly includes a Si-based compound, an acrylic-based compound or an urethane-based compound, and
the single layer formed of the organic thin film has a thickness of 5 to 5,000 nm.

6. The smart glass display device of claim 2, wherein a liquid crystal of the liquid crystal layer is formed in a TN mode (a pre-tilt angle of 0.3 to 5 deg.) or a VA mode (85 to 90 deg.) by performing an alignment process on a transparent electrode portion of the transparent plastic substrate with an organic thin film or an inorganic thin film, and
cell gaps of the first and second shades are 5 μm or less.

7. The smart glass display device of claim 2, wherein the first and second shades are configured in a form of goggles in which left and right eyes are separately manufactured and installed, or the left and right eyes are manufactured together, and
a transmittance of the first and second shades is 5% to 95% based on a transmittance of the substrate.

8. The smart glass display device of claim 1, further comprising:
a display module that receives image and audio information in a wired-wireless manner from an external device including a computer or a camera to increase a dimmable range,
wherein the first and second optical engine units are equipped with optical see-through holographic lenses that allow the image information and the audio information provided virtually in an augmented reality experience to be superimposed on a real world view of a user.

9. The smart glass display device of claim 1, wherein each of the first and second shades has a response speed of 50 ms or less, and has a weight of 100 g or less.
